(19) United States
(12) Patent Application Publication
(10) Pub. No.: US 2013/0205644 A1
(43) Pub. Date: Aug. 15, 2013

(54) Football-Shaped Fishing Lure Weighting System

(71) Applicant: Jeffrey Russell, Desoto, MO (US)

(72) Inventor: Jeffrey Russell, Desoto, MO (US)

(21) Appl. No.: 13/396,624

(22) Filed: Feb. 15, 2012

(51) Int. Cl. A01K 85/00

(52) U.S. Cl. 43/42.39

(57) ABSTRACT

A weighted fishing lure system for use in a covered area comprising: a weighted lure body portion, where said lure body portion includes an football shape; at least one tail extending from one end of the weighted body portion; and a hook assembly, where the hook assembly includes a hook, where said hook inserts into the body portion, further hook assembly including a first eyelet, a hook assembly body, a hook connector, a hook eyelet and a stem extending from the hood eyelet. The weighted body may cover the entire hook for use in the covered area. In an alternative embodiment, the weighted body covers a portion of the hook for use in a clear area.

### BACKGROUND OF THE INVENTION

1. Field of Invention

The present invention relates to a football-shaped fishing lure weighting system for use to on any fishing lure to attract and catch fish in covered (weeded) or open (non-weeded) areas.

2. Description of Related Art

Fishing is a pastime that is enjoyed by numerous individuals. Usually a fisherman uses a rod with a hook in order to catch fish. Various types of bait are used on the hook to attract fish. Fishermen sometimes use live bait such as worms or small insects as a means to attract the fish to bite on the hook. Many fishermen use artificial lures, which may spin or otherwise while being pulled through the water to attract the bite of a fish. Fishing lures come in various shapes and sizes and are constantly being developed to assist fishermen in attracting fish.

### SUMMARY OF THE INVENTION

The present invention relates to a weighted fishing lure system for use in a covered area comprising: a weighted lure body portion, where said lure body portion includes an football shape; at least one tail extending from one end of the weighted body portion; and a hook assembly, where the hook assembly includes a hook, where said hook inserts into the body portion, further hook assembly including a first eyelet, a hook assembly body, a hook connector, a hook eyelet and a stem extending from the hood eyelet. The weighted body may cover the entire hook for use in the covered area. In an alternative embodiment, the weighted body covers a portion of the hook for use in a clear area.

### BRIEF DESCRIPTION OF DRAWINGS

FIG. 1 depicts a hook assembly used in conjunction with the present invention.

FIG. 2 depicts a football shaped weighted body in accordance with the present invention.

FIG. 3 depicts an alternative view of the football shaped weighted body according to the present invention.

### DETAILED DESCRIPTION

The present invention relates to a football-shaped fishing lure weighted system that provides a means to lure and attract fish. The fishing lure weighted system according to present invention is football shaped with at least two tails extending from one end thereof. The shape and sizing of the weight provides a means for directing the fishing lure into various areas for fishing. The fishing lure weight according to the present invention is capable of being utilized in heavily covered areas of fishing lakes or ponds. Many times fishermen seek to attract fish that may lie within weeds or heavily covered areas. The present invention provides a fishing lure weight that is capable of being used in a weed bed or heavily covered area. Without an appropriate type of fishing lure many times it is frustrating to attempt to cast a lure within a covered area. If a fishing lure is incapable of being used in a covered area many times the lure will be covered with weeds or debris if casted into such area and therefore is not available to attract fish. The present invention provides a means to create a weedless version of any fishing lure.

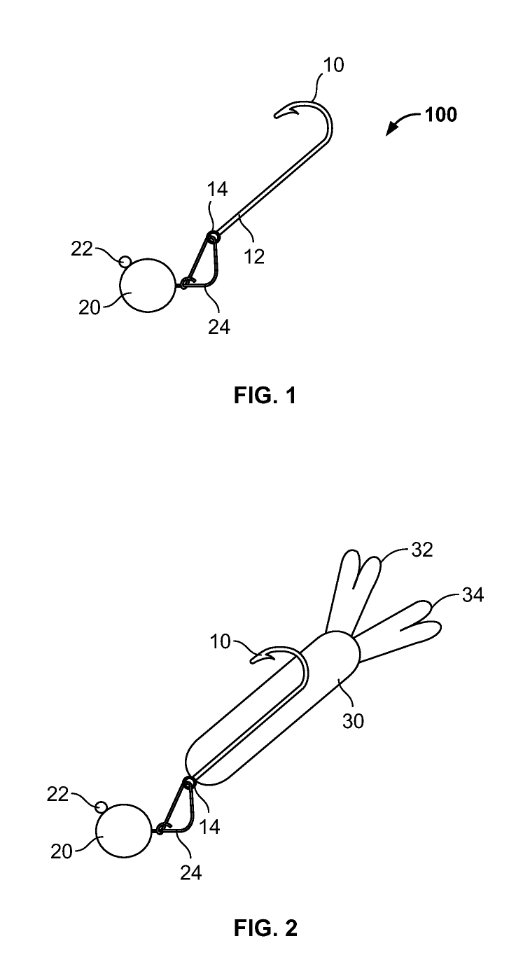

In reference to FIG. 1, a hook assembly 100 is depicted for use in conjunction with the fishing lure weight according to the present invention. The hook assembly 100 includes a first eyelet 22 extending from a body 20. Also extending from the body 20 is a hook connector 24. As shown the hook connector 24 provides a means to attach a hook 10 to the body 20. The first eyelet 22 is attached to the fishing string although not specifically shown. The hook 10 includes an eyelet 14 that attaches to the hook connector 24. The hook 10 includes a stem 12 extending from the eyelet 14. The hook connector 24 is triangular shaped and looped to provide an enclosure to keep the hook eyelet 14 secure during use.

In reference to FIG. 2, the hook 10 is shown with a weighted body 30 in accordance with the present invention attached. The weighted body 30 includes an football-shaped body and a first fin or tail 32 and second tail 34. These tails 32, 34 extend outwardly from the weighted body 30 and the hook 10 as the weighted body 30 is snapped onto the hook. The attachment of the weighted body 30 onto the hook 10 allows the hook 10 to extend from one side of the lure body 30. This positioning of the weighted body 30 onto the hook 10 is for use in a non-weeded area. It is consequently a non-weedless use of the weighted body 30 according to the present invention.

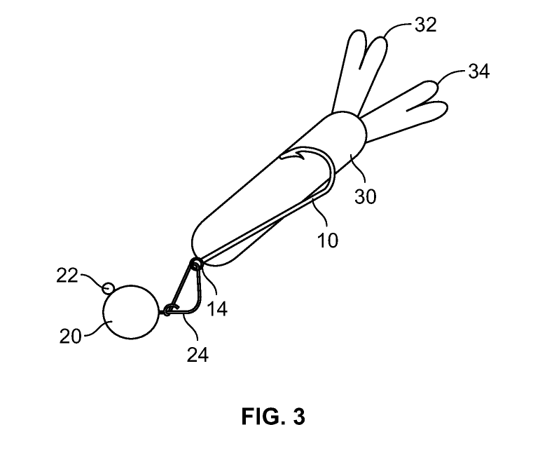

Alternatively FIG. 3, depicts a second use of the weighted body 30 onto hook 10. As shown the weighted body 30 is attached onto the hook 10 where the hook 10 is enclosed within the body of the weighted body 30. This is the weedless version of the weighted body 30 in accordance with the present invention. The weedless version allows for the user to cast the lure in a weeded area without concern for the accumulation of weed onto the hook 10. The positioning of the hook 10 within the body of the weighted body 30 therefore is conducive for fishing in a weeded area. The weighted body 30 may generally fit on any size hook. The body of the lure is comprised of plastic and generally football or football shaped as depicted in FIGS. 2 and 3. The instant invention has been shown and described in what it considers to be the most practical and preferred embodiments. It is recognized, however, that departures may be made there from within the scope of the invention and that obvious modifications will occur to a person skilled in the art.

What is claimed is:

1. A weighted fishing lure system for use in a covered area comprising:
a. a weighted lure body portion, where said lure body portion includes an football shape;
b. at least one tail extending from one end of the weighted body portion; and
c. a hook assembly, where the hook assembly includes a hook, where said hook inserts into the body portion, further hook assembly including a first eyelet, a hook assembly body, a hook connector, a hook eyelet and a stem extending from the hood eyelet.

2. The weighted fishing lure system according to claim 1, where the weighted body covers the entire hook for use in the covered area.

3. The weighted fishing lure system according to claim 1, where the weighted body covers a portion of the hook for use in a clear area.
